(19) United States
(12) Patent Application Publication
(10) Pub. No.: US 2009/0154701 A1
(43) Pub. Date: Jun. 18, 2009

(54) ON DEVICE NUMBER LOCK DRIVEN KEY GENERATION FOR A WIRELESS ROUTER IN WIRELESS NETWORK SECURITY SYSTEMS

(76) Inventors: Ravi K. KOSARAJU, Middle Island, NY (US); Krishnamohan DANTAM, Chelmsford, MA (US)

Correspondence Address: HOFFMAN WARNICK LLC, 75 STATE ST, 14TH FLOOR, ALBANY, NY, 12207, US

(21) Appl. No.: 11/957,681

(22) Filed: Dec. 17, 2007

(51) Int. Cl. H04K 1/00

(52) U.S. Cl. 380/270

(57) ABSTRACT

The present invention solve the problems in the prior art by a embedding a number lock system on the router which serves as a input mechanism for entering the shared key or a shared seed which generates a shared key. A combination of numbers and letters may be used on the dials of the number lock. There is a slider to set the security protocol in use or turn it off. Once the user sets his key combination using the number lock on the device and sets a security mechanism he can go to his computer or a PDA or any device that supports Wi-Fi he will use the same mechanism that he does today with existing technology to enter the shared key and select the security mechanism.

### BACKGROUND OF THE INVENTION

1. Field of the Invention

The present invention generally relates to wireless networks. Specifically, the present invention provides a system and method for easily securing a wireless network using number lock driven key generation for a wireless router in a wireless network security standard.

2. Related Art

One issue with wireless networks in general, and wireless LANS, or WLANs, in particular, involves the need for security. Many early access points could not discern whether or not a particular user had authorization to access the network. Although this problem reflects issues that have long troubled many types of wired networks (it has been possible in the past for individuals to plug computers into randomly available Ethernet jacks and get access to a local network), this did not usually pose a significant problem, since many organizations had reasonably good physical security. However, the fact that radio signals bleed outside of buildings and across property lines makes physical security largely irrelevant to wardrivers. (Wardriving is the act of searching for Wi-Fi wireless networks by a person in a moving vehicle using a Wi-Fi-equipped computer, such as a laptop or a PDA. Wi-Fi, also unofficially known as Wireless Fidelity, is a wireless technology brand owned by the Wi-Fi Alliance intended to improve the interoperability of wireless local area network products based on the IEEE 802.11 standards.) Anyone within the geographical network range of an open, unencrypted wireless network can sniff on all the traffic, gain unauthorized access to internal network resources as well as to the Internet, possibly sending spam or doing other illegal actions using the owner's IP address, all of which are rare for home routers but may be significant concerns for office networks.

If router security is not activated, or if the owner deactivates it for convenience, it creates a free hotspot. Further, virtually all laptop PCs now have Wireless Networking built in (cf. Intel® Centrino technology), thus rendering redundant the need for a third-party adapter (usually a PCMCIA Card or USB dongle). These features might be enabled by default, without the owner ever realizing it, thus broadcasting the laptop's accessibility to any computer nearby.

Modern operating systems such as Linux, Mac OS, or Microsoft Windows XP as the “standard” in home PCs make it very easy to set up a PC as a Wireless LAN “basestation” and using Internet Connection Sharing, thus allowing all the PCs in the home to access the Internet via the “base” PC. However, lack of knowledge about the security issues in setting up such systems often means that someone nearby, such as a next-door neighbor, may also use the internet connection. This is typically done without the wireless network owner's knowledge; it may even be without the knowledge of the intruding user if his computer automatically selects a nearby unsecured wireless network to use as an access point.

Today all (or almost all) access points incorporate Wired Equivalent Privacy (WEP) encryption. (Wired Equivalent Privacy or Wireless Encryption Protocol (WEP) is a scheme to secure IEEE 802.11 wireless networks. It is part of the IEEE 802.11 wireless networking standard. Wireless networks broadcast messages using radio, so are more susceptible to eavesdropping than wired networks.)

However, when a new user is setting up a wireless network, he typically finds it to be a difficult process involving many steps which are needed to set up the encryption scheme in a wireless router the wireless network. For instance, the user needs to connect a cable to the computer and access a program that is running on the wireless router through a browser. Then, he needs to setup the desired WEP encryption parameters. Because of this complicated mechanism, new users often end up leaving the wireless network open and unsecured. No known easy solutions exist for setting up a wireless router to utilize WEP encryption, or other forms of encryption, to set up a secured wireless network. Other wireless encryption systems for wireless networks include WPA and WPA2, both in a class of systems to secure wireless (Wi-Fi) computer networks. It was created in response to several serious weaknesses researchers had found in the previous system, Wired Equivalent Privacy (WEP). WPA implements the majority of the IEEE 802.11i standard, and was intended as an intermediate measure to take the place of WEP while 802.11i was prepared. WPA is designed to work with all wireless network interface cards, but not necessarily with first generation wireless access points. WPA2 implements the full standard, but will not work with some older network cards. Both WEP and WPA encryption schemes are shared key encryption schemes. It always difficult for a new user to set up a secure wireless network, especially if he does not have much familiarity with the computers using the existing mechanisms.

A shared key encryption scheme means that both the wireless client (such as the user's laptop or a wireless PDA or other computing device which has Wi-Fi) and wireless access point (such as a router) agree on a secret key. Presently, the way of setting up a shared key encryption scheme is by the user logging onto the router by connecting it via the browser interface or a CLI (command line interface) and entering the key on the wireless router and then entering the same key on user's wireless client. (Sometimes, it is a seed which generates the key which implies the same seed and the algorithm to generate the key have to be the same on both the wireless client (the user's laptop or a wireless PDA) and wireless router.) This can be very tedious and thwarting for a non-experienced user. It also requires the user to have certain type of client interface to connect to the router (like a browser or a command line terminal session).

Buffalo Technology (see www.bufalo.com) offers a system which is fairly popular. However, the way Buffalo's mechanism works is during the setup phase, the wireless router and the wireless device enter into a key sharing mode when the user presses a button on both of them. The software program, on both sides communicate and, once a key and the protocol are agreed, they begin operating in a secure way. When the user of the Buffalo system press the one touch button on the router the client and the router communicate in a secure way using 64 bit WEP encryption to negotiate a final security mechanism and a key. This is called the association phase. However all the Buffalo products and the clients contain the same key which is hidden from the user. However, any one hacker anywhere in the world hacking figuring this key will make all the Buffalo routers and client software become vulnerable during the association phase if that key became public. There is a need to not having to remember the key so that the administrator doesn't need to go to the router.

The disadvantages of this approach are that the time window, during which initial key sharing takes place, the router is in a insecure mode. This presents an opportunity to an attacker to eavesdrop. Another disadvantage of the prior art systems is that every time a system has a new client wanting to use the router, the administrator has to go and press the one touch button again on the router. So the administrator has to get the router physically at that time.

Another disadvantage is that it requires new software to be installed on client machines for the communication to take place.

By requiring software, it limits the number of clients that can access this service based on software availability - especially with legacy clients and PDA type devices. Further, new software requires that the end user learn how to use. The user may be most likely familiar with the software that he is already using something that is installed on his client.

Every new client, which needs to use the router, has to go through this mechanism of setup during which more opportunities for attackers are presented.

Therefore, there exists a need for a solution which provides a quick and easy way to secure a wireless network without any additional setup and which solves other deficiencies of the related art.

### SUMMARY OF THE INVENTION

The present invention provides a way to secure a wireless network by encrypting data which is passed via a wireless router. In general, when a person buys a wireless router if that person doesn't secure it, someone can eavesdrop on that person's communication. A mechanism to secure this communication is encrypting the data that goes back and forth using a shared key encryption. (Common wireless security protocols that use this are WEP and WPA).

A shared key means both the wireless client (the user's laptop or a wireless PDA) and wireless router agree on a secret key. Today, the way of setting up a shared key is logging onto the router by connecting it via the browser interface or a CLI (command line interface) and entering the key and then entering the same key on the user's wireless client. (Sometimes it is a seed which generates the key which implies the same seed and the algorithm to generate the key have to be the same on both sides.) This can be very tedious and thwarting for a non experienced user. It also requires the user to have certain type of client interface to connect to the router (like a browser or a command line terminal session).

The present invention solves this by a embedding a number lock system on the router which serves as a input mechanism for entering the shared key or a shared seed which generates a shared key. A combination of numbers and letters may be used on the dials of the number lock. There will be a slider to set the security protocol in use or turn it off. Once the user sets his key combination using the number lock on the device and sets a security mechanism he can go to his computer or a PDA or any device that supports WIFI, he will use the same mechanism that he does today with existing technology to enter the shared key and select the security mechanism. This is typically a software application running on the device. The number or dials and the alphanumeric characters on the dials employed may vary depending on various security protocols supported.

The present invention solve the problems in the prior art by a embedding a number lock system on the router which serves as a input mechanism for entering the shared key or a shared seed which generates a shared key. A combination of numbers and letters may be used on the dials of the number lock. There is a slider to set the security protocol in use or turn it off. Once the user sets his key combination using the number lock on the device and sets a security mechanism he can go to his computer or a PDA or any device that supports Wi-Fi, he will use the same mechanism that he does today with existing technology to enter the shared key and select the security mechanism. This is typically a software application running on the device. The number or dials and the alphanumeric characters on the dials employed may vary depending on various security protocols supported.

A wireless network can be secured quickly with a simple numbered lock associated with a wireless router. The present invention adds a number lock to the wireless router and the user just has to press a button to indicate that the wireless network needs to be secured and chooses the appropriate lock number combinations.

The invention provides a simple solution to secure a wireless network for users who are not familiar with computers.

### BRIEF DESCRIPTION OF THE DRAWINGS

These and other features of this invention will be more readily understood from the following detailed description of the various aspects of the invention taken in conjunction with the accompanying drawings in which:

FIG. 1 shows a system, for suitable for storing and/or executing program code, such as the program code of the present invention.

FIG. 2 shows an illustrative communication network for implementing the method of the present invention.

FIGS. 3, 4 and 5 show illustrative user interfaces for implementing the method of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE DRAWINGS

The present invention provides a way to secure a wireless network through the wireless router of the wireless network.

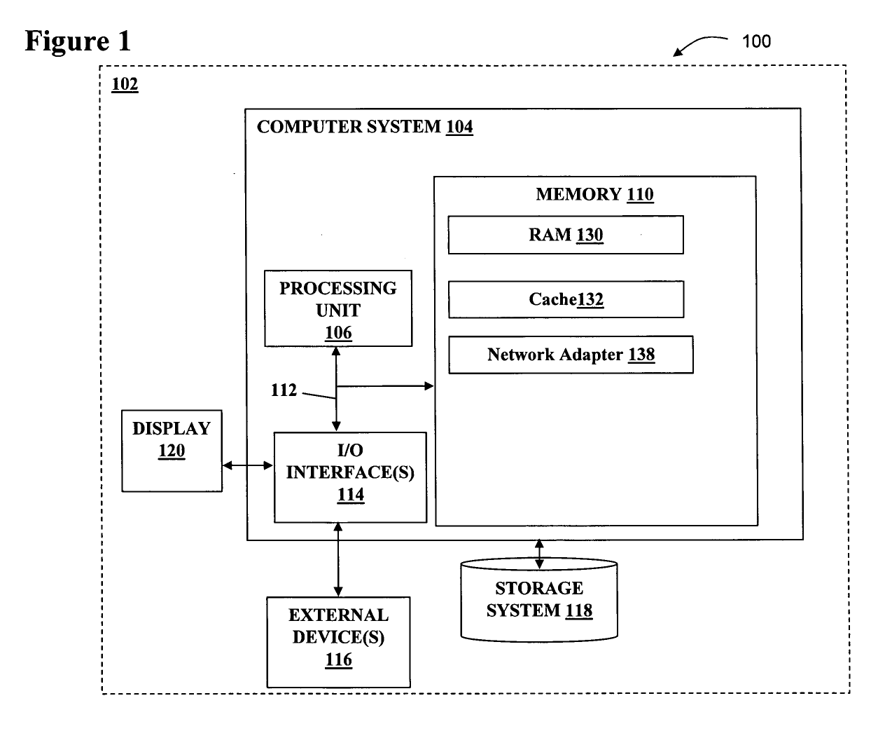

A data processing system, such as that system 100 shown in FIG. 1, suitable for storing and/or executing program code will include at least one processor (processing unit 106) coupled directly or indirectly to memory elements through a system bus. The memory elements can include local memory (RAM 130) employed during actual execution of the program code, bulk storage (storage 118), and cache memories (cache 132) which provide temporary storage of at least some program code in order to reduce the number of times code must be retrieved from bulk storage during execution. Input/output or I/O devices (external devices 116) (including but not limited to keyboards, displays, pointing devices, etc.) can be coupled to the system either directly or through intervening I/O controllers (I/O Interface 114). The data processing system may also be a PDA or any other device having Wi-Fi capability.

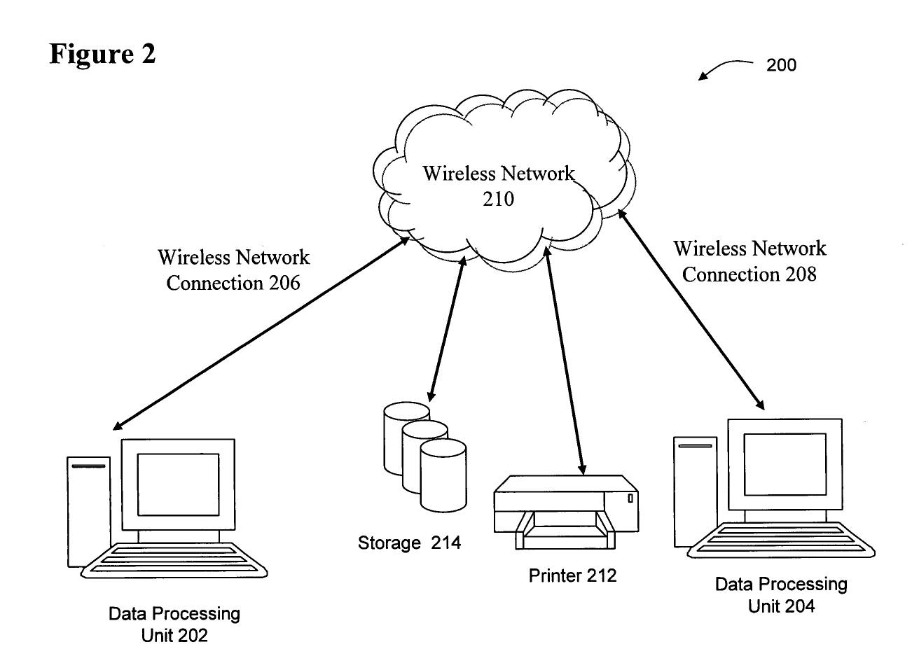

Network adapters (network adapter 138) may also be coupled to the system to enable the data processing system (as shown in FIG. 2, data processing unit 202) to become coupled to other data processing systems (data processing unit 204) or remote printers (printer 212) or storage devices (storage 214) through intervening private wireless networks or public wireless networks (network 210). (A computer network is composed of multiple computers and routers connected together—either directly hard-wired or wirelessly (as is the case with the present invention) using a telecommunication system for the purpose of sharing data, resources and communication. For more information, see http://historyoftheinternet.org/.) Modems, cable modems, Ethernet cards are just a few of the currently available types of network adapters. (A network card, network adapter or NIC (network interface card) is a piece of computer hardware designed to allow computers to communicate over a computer network. It is both an OSI layer 1 (physical layer) and layer 2 (data link layer) device, as it provides physical access to a networking medium and provides a low-level addressing system through the use of MAC addresses. It allows users to connect to each other either by using cables or wirelessly.)

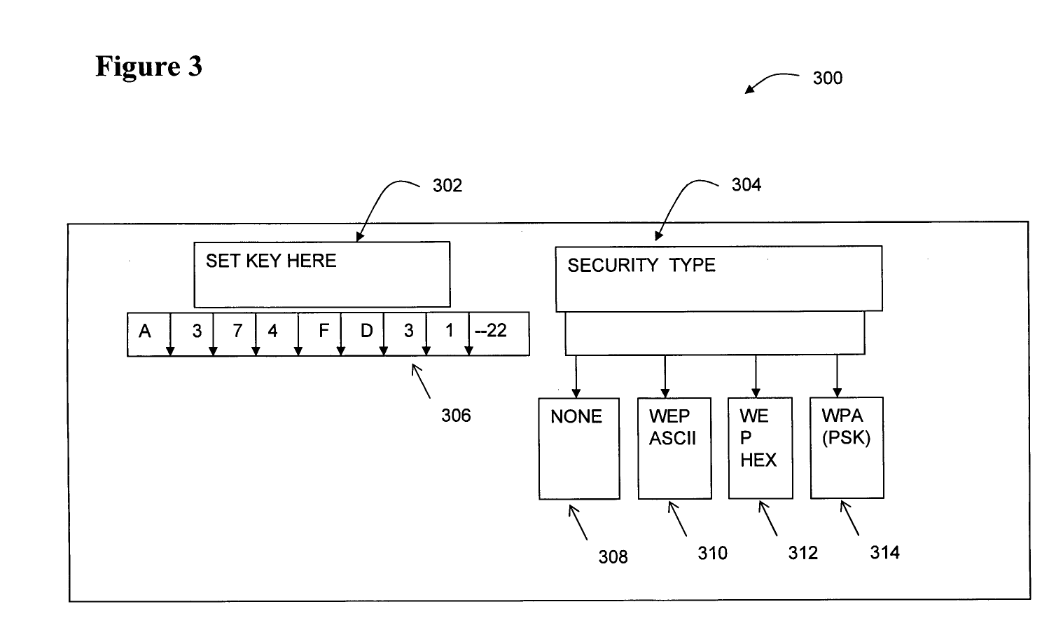

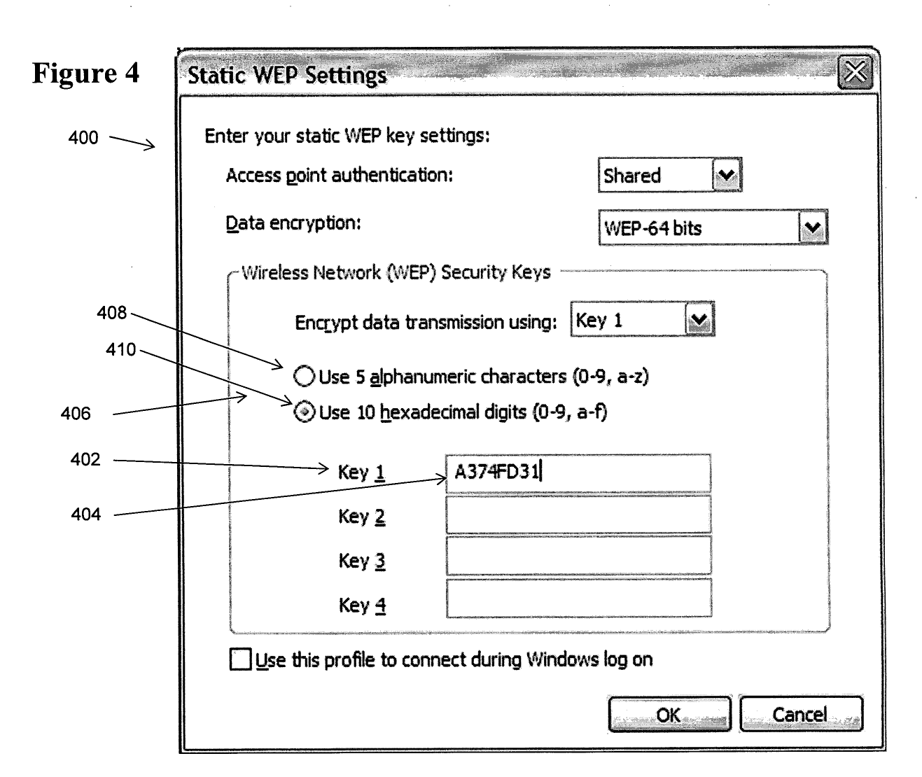

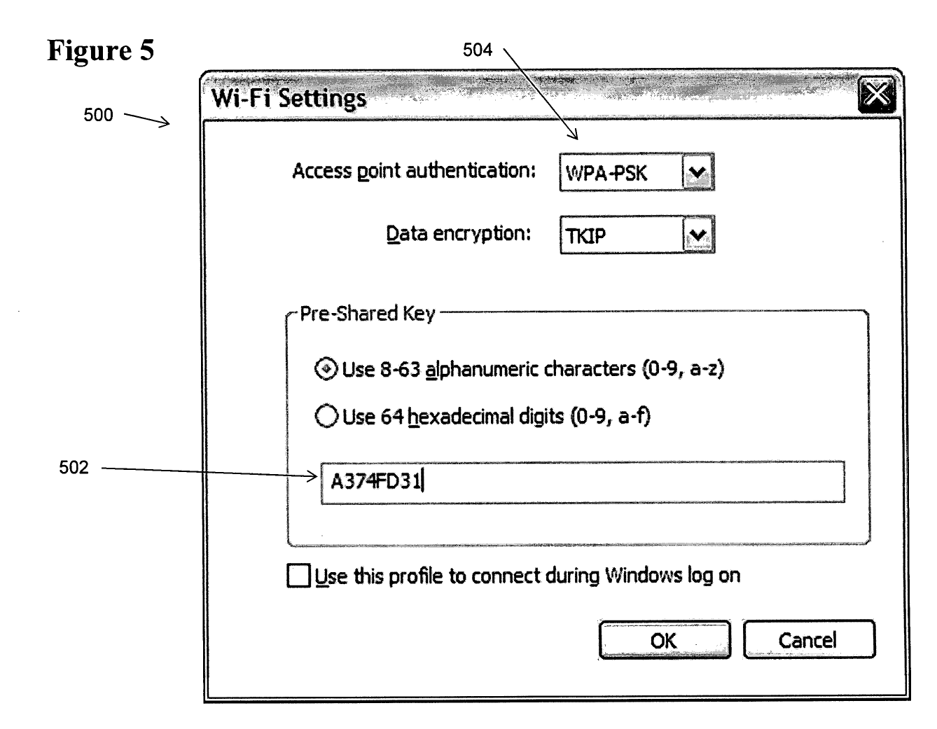

Referring now to FIG. 3, FIG. 4 and FIG. 5, an example user interface 300 and 400 for receiving a key from a user who is implementing the present invention is shown. Specifically, FIG. 3, FIG. 4 and FIG. 5 show a Set Key Here section 302 and Key 1 section 402 for the user to set the key 306/404/502. The set key 306 also acts as a slider so that the user is able to use a mouse to “slide” it to a new position giving it a new value. The user interface provides numbers or dials and alphanumeric characters on the dials to select the shared secret key and the security protocols selected and allows the numbers or dials and alphanumeric characters on the dials to vary depending on various security protocols supported. It also shows a Security Type section 304/406/504 for the user to choose the security type. Example security types are “None” 308 where no security is selected, “WEP ASCII” security type 310/408 where WEP key in ASCII format, “WEP Hex” security type 312/410 where the WEP key is entered by users as a string of Hexadecimal (Hex) characters (0-9 and A-F), and “WPA (PSK)” security type 314 which is in a less secure “pre-shared key” (PSK) mode (shown in FIG. 5), where every user is given the same pass-phrase. In particular, during the setup phase when the server and the client communicate to setup a key ( called association phase) the router changes its SSID to a factory defined value of “ESSID-AOS” and uses a 64 bit WEP based encryption with a hardcoded key in client and router which is not visible to the user. This phase is secure as long as that key hardcoded into the client software and the router remains secure and is same for all the copies of the product. Once it is hacked (the key used during initial setup) and revealed every router and client software that uses this technology become vulnerable as it presents that window of opportunity during association to determine the final key. For more information check http://www.buffalotech.com/files/AOSS_WP_Final.pdf.

The wireless router of the present invention has a Security-On/Security-Off button to control whether the wireless network needs to be secured or not. The router will also have a numbered combination lock. When the Security-On is selected, the user can change the combination lock to select a number that needs to be used to secure the network. The number combination internally generates the WEP Key or other key for other types of encryption schemes to be used by the router.

Depending on the type of security protocol which the user selects using the slider 306, it could require a minimum or maximum number or a fixed number of keys which the user is required to enter for a pass phrase. Some protocols require ASCII characters while others require hexadecimal characters as an input. For example, WEP in 128 bit mode can take a maximum 13 ASCII characters or 26 hexadecimal digits. An LED may be used next to the number lock which lights green, or another color, if the passphrase is valid and red if it is invalid and off if not security is turned on.

When the user is on the computer trying to connect to the wireless network, the user would use a small program to enter the number lock combination and that would generate the same WEP key and connects to the wireless network.

The solution can be used in an exclusively non-PC environment like PCs/PDA's to quickly secure and connect to a WI-FL network. (Partitioning Communication System (PCS) is a high-assurance computer security architecture based on an information flow separation policy. Personal digital assistant (PDA) is an electronic device which can include some of the functionality of a computer, a cell phone, a music player and a camera).

It should be understood that the present invention is typically computer-implemented via hardware and/or software. As such, and client systems and/or servers will include computerized components as known in the art. Such components typically include (among others), a processing unit, a memory, a bus, input/output (I/O) interfaces, external devices, etc. It should also be understood that although a specific embodiment involving wireless routers has been depicted and described, the present invention could be implemented in conjunction with any type of wireless communicating device.

While shown and described herein as a system and method for easily securing a wireless network using number lock driven WEP/WPA key generation for the wireless router, it is understood that the invention further provides various alternative embodiments. For example, in one embodiment, the invention provides a computer-readable/useable medium that includes computer program code to enable a computer infrastructure to easily secure a wireless network using number lock driven WEP/WPA key generation for the wireless router. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory and/or storage system (e.g., a fixed disk, a read-only memory, a random access memory, a cache memory, etc.), and/or as a data signal (e.g., a propagated signal) traveling over a network (e.g., during a wired/wireless electronic distribution of the program code).

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for a user, having a wireless computing device having a user interface, to set up an encryption scheme in a wireless access point, the wireless access point having a number lock system, the computing device being connected to the wireless access point, the method having the following steps:
providing the user on the user interface with a display with a section for selecting a key;
providing the user on the user interface with a display with a section for selecting a security type; and
providing, from the wireless computing device to the wireless access point, the selected key to the wireless access point.

2. The method of claim 1 further including the step of, at the wireless access point, receiving, at the number lock system, the selected key.

3. The method of claim 2 wherein the key is a shared key and the method further comprises the step of the wireless computing device and the wireless access point agreeing on the selected key.

4. The method of claim 2 further including the step of providing the user a sliding mechanism, on the user interface, to set the security protocol in use or turn it off.

5. The method of claim 4 further including the step of providing the user, on the user interface, numbers or dials and alphanumeric characters on the dials to select the shared key and the security protocols selected and the step of allowing the numbers or dials and alphanumeric characters on the dials to vary depending on various security protocols supported.

6. The method of claim 1 further wherein the wireless access device is in a secure mode immediately after the wireless access device and wireless computing device agree on the shared key so that, once the shared key has been set, the communication is secure and never has to enter into a insecure mode.

7. The method of claim 6 wherein the shared key is a WEP ASCII key.

8. The method of claim 6 wherein the shared key is a WEP Hex key.

9. The method of claim 6 wherein the shared key is a WPA PSK key.

10. A computer program product in a computer readable medium for operating in a system comprising a network I/O, a CPU, and one or more databases, for implementing a method for easily securing a wireless network using number lock driven WEP key generation for the wireless router, the method comprising the steps of:
providing the user on the user interface with a display with a section for selecting a key;
providing the user on the user interface with a display with a section for selecting a security type; and
providing, from the wireless computing device to the wireless access point, the selected key to the wireless access point.

11. The computer program product of claim 10 wherein the method further comprises the step of, at the wireless access point, receiving, at the number lock system, the selected secret key.

12. The computer program product of claim 11 wherein the key is a shared key and the method further comprises the step of the wireless computing device and the wireless access point agreeing on the selected key.

13. The computer program product of claim 11 wherein the method further comprises the step of providing the user a sliding mechanism, on the user interface, to set the security protocol in use or turn it off.

14. The computer program product of claim 13 wherein the method further comprises the step of providing the user, on the user interface, numbers or dials and alphanumeric characters on the dials to select the shared secret key and the security protocols selected and the step of allowing the numbers or dials and alphanumeric characters on the dials to vary depending on various security protocols supported.

15. The computer program product of claim 10 further wherein the wireless access device is in a secure mode immediately after the wireless access device and wireless computing device agree on the shared key so that, once the shared key has been set, the communication is secure and never has to enter into a insecure mode.

16. The computer program product of claim 15 wherein the shared key is a WEP ASCII key.

17. The computer program product of claim 15 wherein the shared key is a WEP Hex key.

18. The computer program product of claim 15 wherein the shared key is a WPA PSK key.
